(19) United States
(12) Patent Application Publication
(10) Pub. No.: US 2026/0020052 A1
(43) Pub. Date: Jan. 15, 2026

(54) DISTRIBUTED/SEMI-CENTRALIZED SELECTION OF COORDINATED-RESTRICTED TARGET WAKE TIME (C-RTWT) SLOTS

(71) Applicant: Cisco Technology, Inc., San Jose, CA (US)

(72) Inventors: Brian Donald Hart, Sunnyvale, CA (US); Malcolm Muir Smith, Richardson, TX (US); Binita Gupta, San Diego, CA (US)

(21) Appl. No.: 19/264,937

(22) Filed: Jul. 10, 2025

Related U.S. Application Data
(60) Provisional application No. 63/669,375, filed on Jul. 10, 2024.

(51) Int. Cl. H04W 74/04; H04W 56/00

(52) U.S. Cl. CPC H04W 74/04; H04W 56/001

(57) ABSTRACT

A method for coordinating transmissions by an access point (AP) of a plurality of APs in a wireless network includes monitoring, by the AP, a plurality of C-RTWT (Coordinated-Restricted Target Wake Time) agreements in a neighborhood of the AP; determining, by the AP and using the plurality of C-RTWT agreements, a parameter indicative of congestion or sparsity of Start Time Protection Rules (STPRs) in the neighborhood; and modifying, by the AP, at least one C-RTWT agreement of the plurality of C-RTWT agreements to reach a target spacing among the STPRs.

### CROSS-REFERENCE TO RELATED APPLICATIONS

This application claims priority to and benefit of U.S. Provisional Application No. 63/669,375 filed on Jul. 10, 2024, the entire content of which is incorporated herein by reference.

### TECHNICAL FIELD

The present disclosure relates to wireless communication, and in particular to coordination among multiple access points (APs) using distributed or semi-centralized selection of coordinated-restricted target wake time (C-RTWT) slots.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 (802.11bn) and Wi-Fi 9, each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6/6E included enhanced orthogonal frequency-division multiple access (OFDMA) and target wake time (TWT) mechanisms and included greater frequency and improved overall spectral efficiency and power management and better performance in crowded areas. Wi-Fi 7 (802.11be) delivers speeds of up to 30 Gbps, utilizing multi-band operation, wider bandwidth, advanced MIMO techniques, and improved modulation schemes. Wi-Fi 7 also focuses on reducing latency and enhancing security features.

Wi-Fi 8 (802.11bn) aims to revolutionize wireless connectivity by providing ultra-high reliability enabling rich experiences for QoS demanding applications such as cloud gaming, AR/VR, industrial IoT, wireless TSN etc. Wi-Fi 8 is expected to introduce advancements like seamless roaming, multi-AP coordination for predictable QoS, enhanced power saving and advanced beamforming techniques paving the way for futuristic applications and seamless connectivity experiences.

As Wi-Fi technology continues to evolve, each new Wi-Fi generation brings improvements that address the growing demands of modern networks, including increased device density, higher data rates, lower latency, improved reliability and better overall network performance. These advancements play a crucial role in enabling emerging technologies, supporting the proliferation of smart devices, and transforming the way we connect and communicate in an increasingly interconnected world.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of an example wireless communication network according to some aspects of the present disclosure.

FIG. 2A illustrates a network diagram illustrating an example network environment of multi-link operation according to some aspects of the present disclosure.

FIG. 2B illustrates an illustrative schematic diagram for connectivity of an access point (AP) multi-link device (MLD) with multiple affiliated APs to a non-AP MLD with multiple affiliated non-AP stations (STAs) according to some aspects of the present disclosure.

FIG. 3 illustrates an example of a seamless mobility domain according to some aspect of the present disclosure.

FIGS. 4A to 4F each illustrate example methods of operation according to some aspects of the present disclosure.

FIG. 5 illustrates another example method of operation according to some aspects of the present disclosure.

FIG. 6 illustrates an example of a computing system in accordance with certain embodiments.

### DETAILED DESCRIPTION OF EXAMPLE EMBODIMENTS

Various embodiments of the disclosure are discussed in detail below using examples. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

### Overview

Aspects of the present disclosure are directed to combining two time-based MAPC technologies C-RTWT (Coordinated-Restricted Target Wake Time) and C-TDMA (Coordinated Time Division Multiple Access) such that C-RTWT alignment and suitable density may be achieved between different APs or different administrative domains by spreading out STPRs at APs to improve deterministic latency, reduce contention, and enhance QoS (Quality of Service) for time-sensitive applications such as XR, industrial IoT, and real-time video. Further, the spreading out of the STPRs at APs is determined based upon C-RTWT agreements shared by an AP with neighboring APs of the AP.

C-RTWT is a mechanism that coordinates multiple APs and/or STAs wake and transmit schedules within a BSS (Basic Service Set) or even across multiple BSSs. An AP schedules non-overlapping time slots during which specific APs and/or STAs are allowed to transmit or receive. These time slots are “restricted” in the sense that only the designated APs and/or STAs may access the medium, minimizing contention and collisions. C-TDMA extends the concept of TDMA by applying it in a coordinated Wi-Fi environment, ensuring scheduled, contention-free access to the medium for multiple APs and/or STAs. In C-TDMA, the AP assigns dedicated time slots for STAs or neighboring APs to transmit.

In one aspect, a method for coordinating transmissions by an AP of a plurality of APs in a wireless network is provided. The method includes monitoring, by the AP, a plurality of C-RTWT agreements in a neighborhood of the AP. The method includes determining, by the AP and using the plurality of C-RTWT agreements, a parameter indicative of congestion or sparsity of Start Time Protection Rules (STPRs) in the neighborhood, and modifying, by the AP, at least one C-RTWT agreement of the plurality of C-RTWT agreements to reach a target spacing among the STPRs.

In another aspect, modifying the at least one C-RTWT agreement includes determining a spacing between two most-widely-spaced STPRs among the STPRs, and determining a corresponding Service Interval (SI) and a corresponding Service Start Time (SST) of the at least one C-RTWT agreement based on the spacing.

In another aspect, the corresponding SI and the corresponding SST are set equal to a midpoint between the two most-widely-spaced STPRs if the spacing is equal to a first threshold.

In another aspect, the first threshold is twice a defined time period.

In another aspect, the corresponding SI and the corresponding SST are set equal to a threshold time after an earlier STPR of the two most-widely-spaced STPRs if the spacing exceeds twice a first threshold.

In another aspect, the plurality of C-RTWT agreements is a first plurality of C-RTWT agreements, and the method further includes generating a second plurality of C-RTWT agreements if the spacing exceeds a threshold, wherein each C-RTWT agreement of the second plurality of C-RTWT agreements having a corresponding index, and determining a corresponding SI and a corresponding SST for each C-RTWT agreement of the second plurality of C-RTWT agreements to be equal to the corresponding index multiplied by a threshold time after an earlier STPR of the two most-widely-spaced STPRs, the threshold being determined as a multiple of a defined time period.

In another aspect, a number of the second plurality of C-RTWT agreements is determined based on the spacing and the threshold time.

In another aspect, the AP cannot have a C-RTWT agreement with a STPR rate higher than a corresponding STPR rate of any neighboring AP.

In another aspect, the AP cedes any C-RTWT agreement to a neighboring AP with a lower STPR upon receiving a demand from the neighboring AP.

In another aspect, the method further includes detecting that a neighboring AP has stopped corresponding transmissions, and modifying the at least one C-RTWT agreement in response to detecting that the neighboring AP has stopped the corresponding transmissions.

In another aspect, the method further includes determining that at least one of STPRs of the AP is drifting into at least one STPR of a neighboring AP, modifying a corresponding SST of the at least one C-RTWT agreement in response to the determining that the at least one of STPRs is drifting into the at least one STPR of the neighboring AP, and signaling adjacent APs including the neighboring AP that the corresponding SST has been modified.

In another aspect, the method further includes determining that modifying a corresponding SST of the at least one C-RTWT agreement increases average spacing between the STPRs across all neighboring APs, modifying the corresponding SST in response to determining that the average spacing will increase, and signaling adjacent APs including all neighboring APs that the corresponding SST has been modified.

In another aspect, the method further includes signaling modifications to the at least one C-RTWT agreement to a neighboring AP via a secure tunnel.

In one aspect, a method for coordinating transmissions by an access point (AP) of a plurality of APs in a wireless network is provided. The method includes synchronizing a clock of the AP with a clock reference shared by the plurality of APs in an administrative domain, and coordinating allocation of C-RTWT to allocate a service period to the access point using the clock reference shared by the plurality of APs.

In another aspect, the clock reference is available to each AP of the plurality of APs in each administrative domain of the plurality of administrative domains.

In another aspect, the clock reference is based on a GPS clock.

In one aspect, an access point (AP) of a plurality of APs in a wireless network is provided. The AP includes at least one memory configured to store machine-executable instructions, and at least one processor communicatively coupled with the at least one memory and configured to execute the machine-executable instructions to perform operations including monitoring a plurality of C-RTWT (Coordinated-Restricted Target Wake Time) agreements in a neighborhood of the AP; determining, using the plurality of C-RTWT agreements, a parameter indicative of congestion or sparsity of Start Time Protection Rules (STPRs) in the neighborhood; and modifying at least one C-RTWT agreement of the plurality of C-RTWT agreements to reach a target spacing among the STPRs.

In another aspect, modifying the at least one C-RTWT agreement includes determining a spacing between two most-widely-spaced STPRs among the STPRs, and determining a corresponding Service Interval (SI) and a corresponding Service Start Time (SST) of the at least one C-RTWT agreement based on the spacing.

In another aspect, the corresponding SI and the corresponding SST are set equal to a midpoint between the two most-widely-spaced STPRs if the spacing is equal to a first threshold, and the first threshold is twice a defined time period.

In another aspect, the corresponding SI and the corresponding SST are set equal to a threshold time after an earlier STPR of the two most-widely-spaced STPRs if the spacing exceeds twice a first threshold.

In one aspect, a non-transitory computer-readable media includes computer-readable instructions stored thereon, which, when executed by at least one processor of an access point (AP), cause the AP to: monitor a plurality of C-RTWT (Coordinated-Restricted Target Wake Time) agreements in a neighborhood of the AP; determine, using the plurality of C-RTWT agreements, a parameter indicative of congestion or sparsity of Start Time Protection Rules (STPRs) in the neighborhood; and modify at least one C-RTWT agreement of the plurality of C-RTWT agreements to reach a target spacing among the STPRs.

### EXAMPLE EMBODIMENTS

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum, and power efficiency calls for updates or amendments to the standard to keep up with them. As such, Wi-Fi generally has a new amendment after every few years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency though higher data rates were also included. The next expected update to IEEE 802.11 is coined as Wi-Fi 8. Wi-Fi 8 will attempt to further improve reliability and minimize latency to meet the ever-growing demand for the Internet of Things (IoT), high resolution video streaming, low-latency wireless services, wireless Time Sensitive Networking (TSN) etc.

Multiple Access Point (AP) coordination and transmission in Wi-Fi refers to the management of multiple access points in a wireless network to avoid interference and ensure efficient communication between the STA devices and the network. When multiple access points are deployed in a network—for instance in buildings and office complexes—they operate on the same radio frequency, which can cause interference and degrade the network performance. To mitigate this issue, access points can be configured to coordinate their transmissions and avoid overlapping channels.

Wi-Fi 8 supports multiple access point (Multi-AP) coordination technologies including coordinated time division multiple access (C-TDMA), coordinated spatial re-use (C-SR), multi-AP coordination service period (MAPC-SP), coordinated-restricted target wake time (C-RTWT), Coordinated Orthogonal Frequency Division Multiple Access (C-OFDMA), coordinated beamforming (C-BF), joint transmission, etc., to collaborate and coordinate resource allocation for optimized performance. Among different multi-AP coordinating technologies, two time-based multi-access point coordination (MAPC) technologies C-RTWT and C-TDMA are proposed to be combined in order for C-RTWT to be used to force the start time protection rule (STPR) on to an adjacent basic service set (BSS) such that at the start of each C-RTWT service period (SP), one AP can transmit at a known time low latency or low collision probability.

Once the AP becomes the TXOP holder (e.g., an AP that has gained access to the wireless medium for a specific duration), then the AP either performs access point to access point (AP2AP) polling to establish how much downlink and uplink (DL+UL) traffic is buffered at APs and/or stations (STAs) in other BSSs and/or to determine priority and/or delay or expiry imminence for other APs or STAs and/or for the BSS of the AP. Alternatively, the AP uses prior information about periodic traffic in its own and other BSSs to select other APs and then performs C-TDMA to grant time to the AP itself and neighboring APs according to the amount, priority, and delay or expiry imminence of the buffered traffic.

However, the above approach works well only if the APs can spread out their C-RTWT allocations. For example, each AP has a single RTWT flow leading to a C-RTWT SP starting every 12 msec. Accordingly, when there are 6 overlapping APs, there is a STPR occurring every 2 milliseconds (ms). Additionally, if there is a clock offset between APs or other APs start their BSS or switch channels, or existing APs depart, then the gaps between STPR occurrences can grow very small (e.g., 0.5 or 0.1 msec) or very large (e.g., 4 or 6 or 12 msec). A very short gap leads to inefficiency since the physical layer protocol data units (PPDUs) are very short and the short interframe space (SIFS), preamble, and/or block acknowledgement (BA) overheads dominate. A very long gap decreases quality of service (QoS) since a traffic burst has to wait a long time (4, 6 or 12 msec) before receiving service.

Aspects of the present disclosure will address the deficiencies and gaps described above.

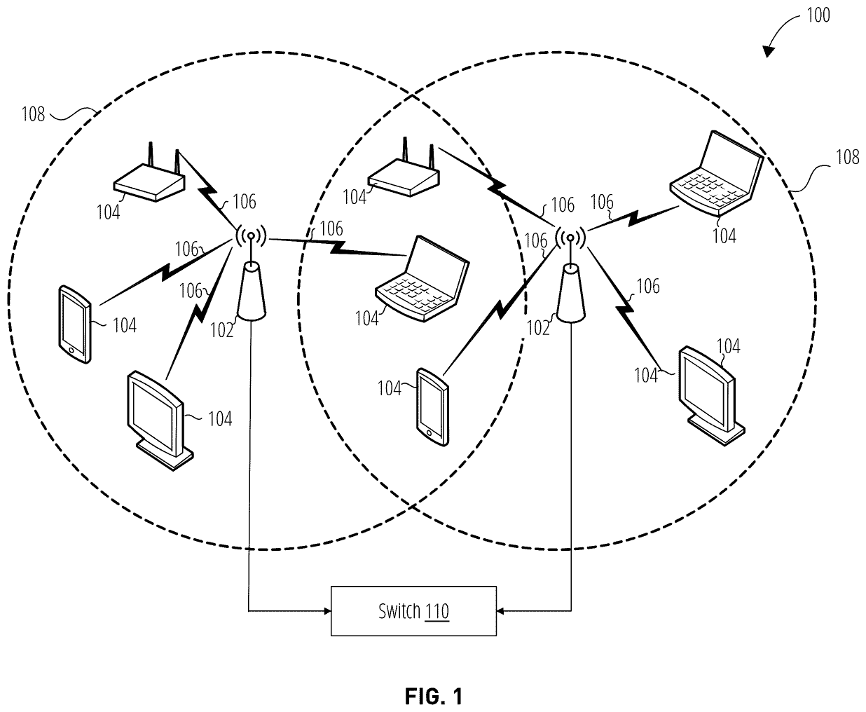

FIG. 1 illustrates a block diagram of an example wireless communication network according to some aspects of the present disclosure. According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the wireless communication network 100 may implement future versions and amendments of the wireless communication protocol standards and amendments thereof such as 802.11bn and be modified according to the present disclosure to include the features contained herein.

Wireless communication network 100 may include numerous wireless communication devices such as an AP, which can be one or more of a non-MLD AP, an AP affiliated with an AP MLD, and/or an AP MLD. In the examples presented herein, the AP can exclude an upper UMAC. Therefore, the AP can include the lower UMAC, LMAC, and/or PHY. Additionally, the WLAN can include one or more of STAs 104, which can be one or more of a non-MLD STA, a STA affiliated with a non-AP MLD, and/or a non-AP MLD. As illustrated, wireless communication network 100 also may include multiple APs such as APs 102 (may also be referred to as simply AP). APs 102 can be coupled to one another through a switch 110. While APs 102 are shown as being coupled to one another through switch 110, wireless communication network 100 can provide another device that allows the coupling of multiple APs. In another example, switch 110 can be a network controller configured to coordinate and manage operations of different APs such as APs 102.

Each of STAs 104 also may be referred to as a mobile station (MS), a mobile device, a mobile handset, a wireless handset, an access terminal (AT), a user equipment (UE), a subscriber station (SS), client, or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STAs 104 can be referred to as clients and/or client devices.

Any one of APs 102 and an associated set of STAs (e.g., STAs 104) may be referred to as a basic service set (BSS), which is managed by a respective AP of APs 102. FIG. 1 additionally shows an example coverage area 108 of the each of APs 102, which may represent a basic service area (BSA) of wireless communication network 100. As illustrated, three of STAs 104 are within the BSA of each of APs 102. The BSS may be identified to users by a service set identifier (SSID), where the BSS might be one of many in the SSID. The BSS may be identified to other devices by a unique (or substantially unique) basic service set identifier (BSSID). One or more of APs 102 periodically broadcasts beacon frames (“beacons”) including the BSSID to enable STAs 104 within a wireless range of APs 102 to “associate” or re-associate with APs 102 to establish a respective communication link of communication links 106 (hereinafter also referred to as a “Wi-Fi link”), or to maintain communication links 106, with APs 102. For example, the beacons may include an identification of a primary channel used by respective AP of APs 102 as well as a timing synchronization function for establishing or maintaining timing synchronization with APs 102. APs 102 may provide communication links 106 to STAs 104 and therefore access to external networks. While the example has been described in regard to APs 102 and STAs 104, the present disclosure extends such that an AP may provide access to external networks to various STAs in a WLAN via communication links 106.

To establish communication links 106 with any one of APs 102, each of STAs 104 is configured to perform passive or active scanning operations (“scans”) on frequency channels in one or more frequency bands (for example, the 2.4 GHz, 5 GHz, 6 GHz, or 60 GHz bands). To perform passive scanning, STAs 104 listen for beacons, which are transmitted by a respective AP of APs 102 at or near a periodic time referred to as the target beacon transmission time (TBTT) (measured in time units (TUs) where one TU may be equal to 1024 microseconds (μs)). To perform active scanning, STAs 104 generate and sequentially transmits probe requests on each channel to be scanned and listens for probe responses from APs 102. STAs 104 may be configured to identify or select an AP and thence a selected AP of APs 102 with which to associate based on the scanning information obtained through the passive or active scans, and to perform authentication and association operations to establish the communication links 106 with the selected AP of APs 102. The selected AP of APs 102 assigns an association identifier (AID) to STAs 104 at the culmination of the association operations, which selected AP of APs 102 uses to improve the efficiency of certain signaling to the STAs 104.

The present disclosure modified the WLAN radio and baseband protocols for the PHY and medium access controller (MAC) layers. APs 102 and STAs 104 transmit and receive wireless communications (hereinafter also referred to as “Wi-Fi communications”) to and from one another in the form of PHY protocol data units (PPDUs). APs 102 and STAs 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

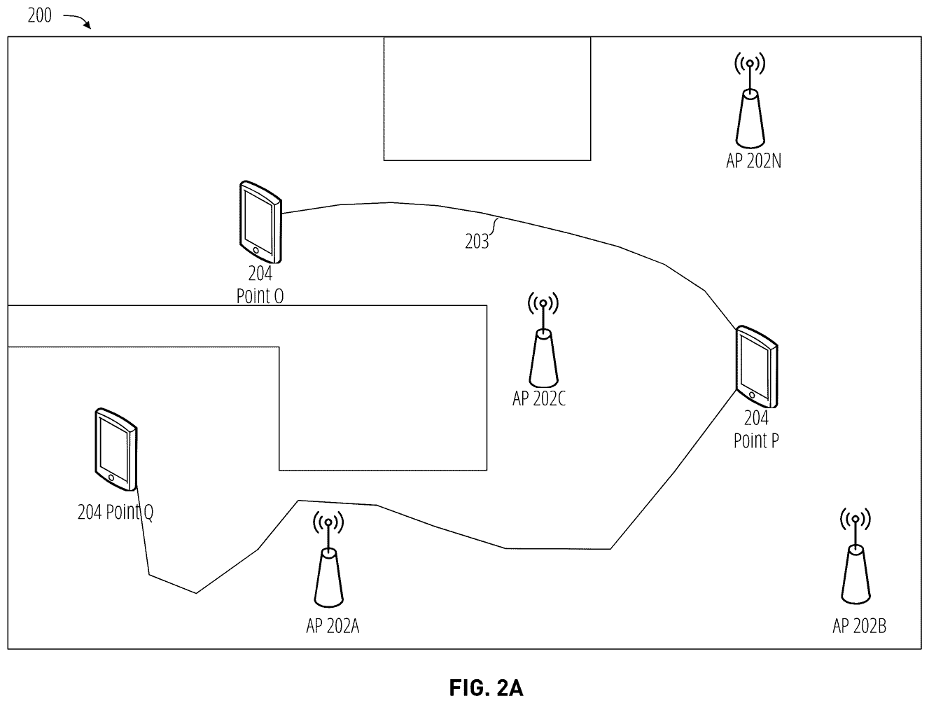

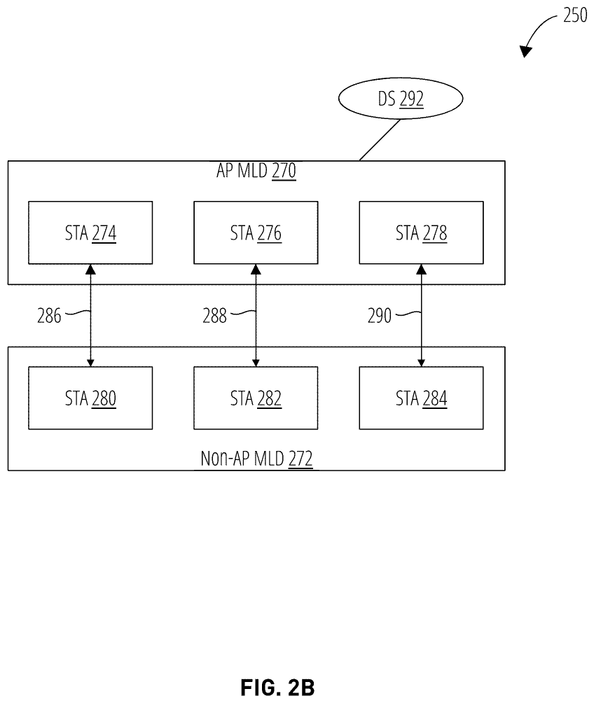

FIG. 2A illustrates an example of a single floor of building equipped with wireless communication according to some aspects of the present disclosure. While only a single floor 200 is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more APs. As illustrated, the single floor 200 includes AP 202A, AP 202B, AP 202C, and AP 202N. Each of the AP 202A, AP 202B, AP 202C, and/or AP 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP of AP 202A, AP 202B, AP 202C, and AP 202N may substantially overlap with the coverage of another AP of the AP 202A, AP 202B, AP 202C, and AP 202N.

As illustrated by line 203, STA 204 can move from point O to point P to point Q. When a STA 204 is moving around on a given floor, one or more of AP 202A, AP 202B, AP 202C, and AP 202N can be considered to be nearest to STA 204. Nearest as used in relation to AP 202A, AP 202B, AP 202C, AP 202N and STA 204 can include being physically nearest (for example, a Euclidean distance on the floor) and/or pathloss-nearest (for example, having the lowest wireless attenuation (pathloss) between a subset of APs, among all the APs, and the STA). Additionally, the pathloss-nearest approach can be used to reduce the likelihood of connection between an AP on a floor above or below STA 204. The location of the AP on the floor above or below might be closer in a Euclidean sense, but also not be a desirable AP for the connection of the device or station due to the floor location and/or possible signal interruption. The location of the AP on the floor above or below might be closer in a straight line and/or Euclidean sense, but also not be a desirable AP for the connection of the device or station due to the floor location and/or possible signal interruption. Additionally, the coverage of one or more APs can at least partially overlap with the coverage of one or more other APs. The present disclosure provides for selecting the AP and/or providing a communication pathway from one or more STA through one or more APs.

FIG. 2B depicts an illustrative schematic diagram for MLO between an AP MLD with affiliated logical entities and a non-AP MLD with affiliated logical entities according to some aspects of the present disclosure.

Referring to FIG. 2B, schematic diagram 250 may include two multi-link logical entities AP MLD 270 and Non-AP MLD 272. AP MLD 270 may include physical and/or logical affiliated AP such as AP 274, AP 276, and AP 278 operating in different channels and typically different frequency bands (e.g., 2.4 GHz, 5 GHz, and 6 GHz). AP 274, AP 276, and AP 278 may be the same as or similar to any one of the APs described above. Non-AP MLD 272 may include STA 280, STA 282, and STA 284, which may be the same as or similar to any of the STAs as described herein.

AP 274 may communicate with STA 280 via link 286. AP 276 may communicate with STA 282 via link 288. AP 278 may communicate with STA 284 via link 290.

AP MLD 270 is shown in FIG. 2B to have access to a distribution system (DS) such as DS 292, which is a system used to interconnect a set of BSSs to create an extended service set (ESS).

It should be understood that although the example shows three logical entities within the AP MLD and the three logical entities within the non-AP MLD, this is merely for illustration purposes and that other numbers of logical entities within each of the AP MLD and Non-AP MLD may be envisioned. The example Wi-Fi systems and MLO described above with reference to FIGS. 1 and 2A-2B provide examples of simplified and example systems of the present disclosure.

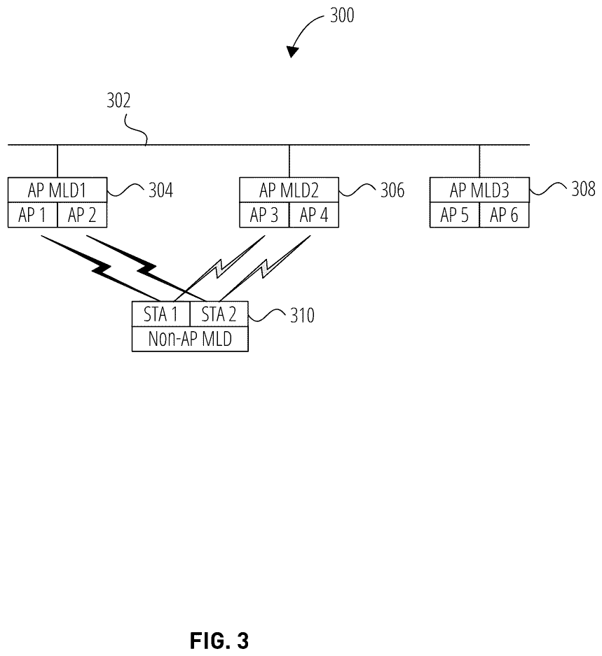

FIG. 3 illustrates an example architecture 300 in which multi-AP coordination technologies may be practiced according to some aspect of the present disclosure. The architecture 300 includes a DS 302 (may be the same as the DS 292) that is a logically connected entity that includes AP MLD1 304, AP MLD2 306, and AP MLD3 308, all of which can form an ESS (e.g., all AP MLDs which are part of a campus ESS network). Architecture 300 also shows a non-AP MLD 310 that may be connected to AP MLD1 304.

AP MLD1 304 may include one or more APs such as AP1 and AP2. AP1 and AP2 may be different physical APs (or AP interfaces) co-located in AP MLD1 304. Similarly, AP MLD2 306 may include one or more APs such as AP3 and AP4. AP3 and AP4 may be different physical APs (or AP interfaces) co-located in AP MLD2 306. Similarly, AP MLD3 308 may include one or more APs such as AP5 and AP6. AP5 and AP6 may be different physical APs (or AP interfaces) co-located in AP MLD3 308. The number of AP MLDs and/or the number of respective APs of each AP MLD is not limited to the example numbers shown in FIG. 2B and may include more or less.

In one example, AP MLD1 304, AP MLD2 306, and AP MLD3 308 may be located in different geographical locations (e.g., different rooms of the same building, different floors of the same building, different buildings of the same campus or area, etc.).

The non-AP MLD 310 may be any known or to be developed device capable of establishing one or more wireless communication links with one or more of AP MLD1 304, AP MLD2 306, and/or AP MLD3 308. As a non-limiting example, non-AP MLD 310 may be a mobile device having two wireless interfaces, each of which may correspond to one of STA 1 or STA 2. In one example, each one of STA 1 and STA 2 may operate on a different link (e.g., 5 GHz for STA 1 and 6 GHz for STA 2). The number of non-AP MLDs and/or STAs associated with each is not limited to that shown in FIG. 3 and may be more or less.

As shown in FIG. 3, the non-AP MLD 310 is associated with the architecture 300 with multiple links setup with the AP MLD1 304 (for example, 2.4 GHz link with the AP1 for the STA 1 and 5 GHz link with the AP2 for the STA 2). For one of the links (for example, 2.4 GHz), the AP MLD1 304 may detect a weak RSSI. As a result, AP MLD1 304 determines a specific roaming target AP3 of AP MLD2 306 for that link to Switch to. Similarly, the same process may be performed for the other link (for example, the 5 GHz) to Switch to a link with STA 4 on the AP MLD2 205.

Hereinafter, one or more example embodiments will be described for combining C-RTWT and C-TDMA while achieving C-RTWT alignment and suitable density between different APs in the same administrative domain and/or across different administrative domains. Procedures will be defined for processing at APs to help spread out their STPRs, where this spreading can be readily determined from the standardized protocol by which APs share C-RTWT agreements with neighboring APs.

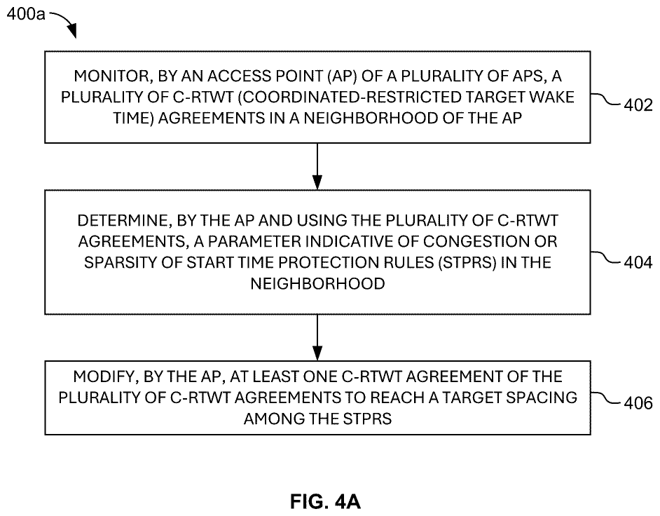

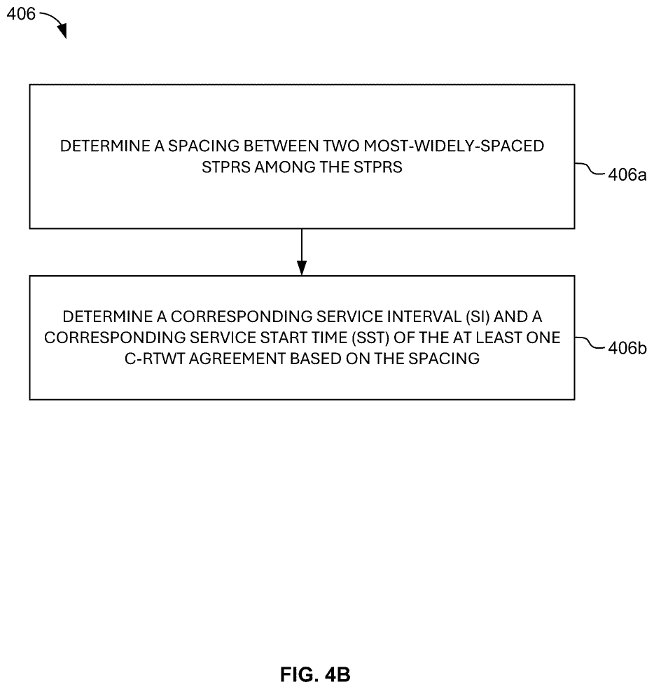

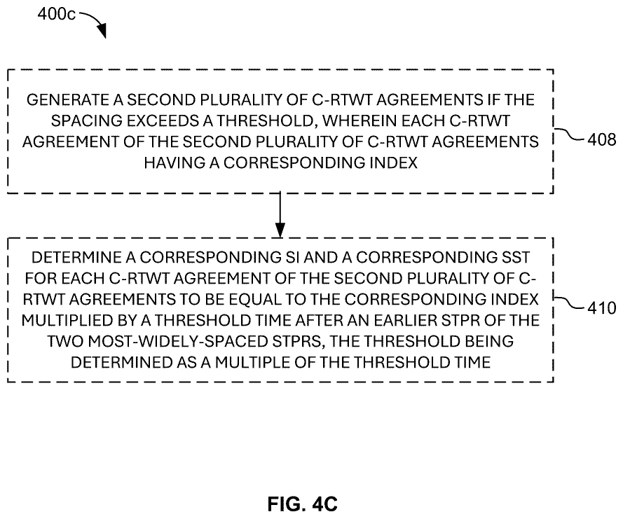

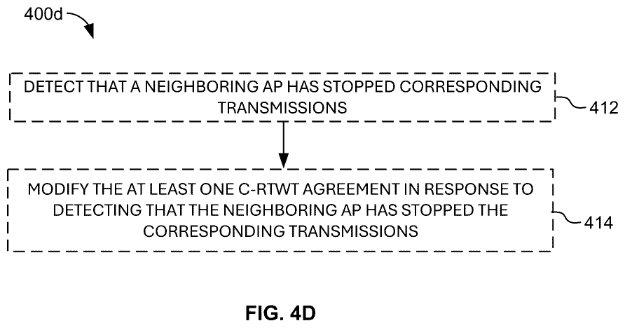

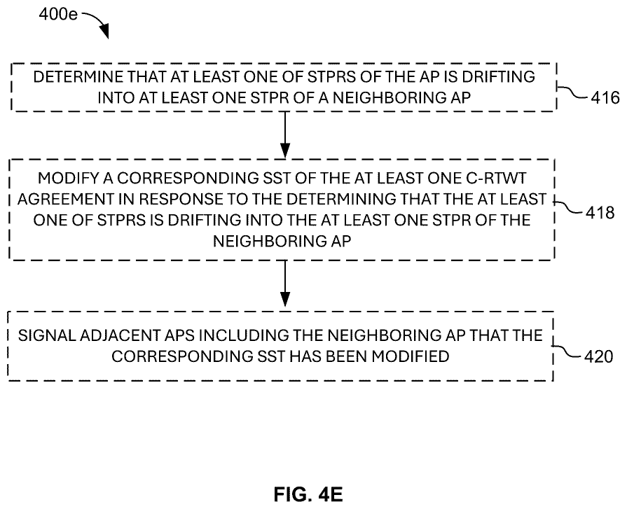

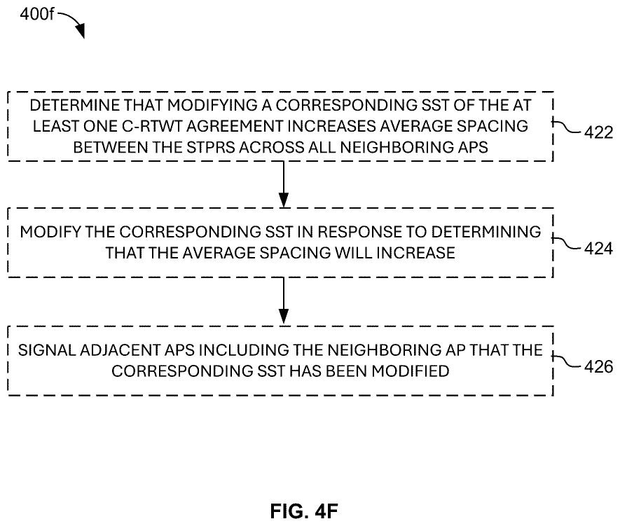

FIGS. 4A to 4F each illustrate example methods of operation according to some aspects of the present disclosure. The method operations may be performed by an AP (e.g., AP MLD1 304) of a plurality of APs (e.g., AP MLD1 304, AP MLD2 306, and AP MLD3 308) for coordinating transmissions in a wireless network. Alternatively, operations of FIG. 4A may be performed by an AP or network controller such as switch 110 described above as being able to operate as a centralized controller of different APs.

FIG. 4A illustrates an example flow-chart 400a of method operations according to some aspects of the present disclosure.

The method operations may include monitoring, at step 402, a plurality of C-RTWT (Coordinated-Restricted Target Wake Time) agreements in a neighborhood of the AP. As described herein, the AP may monitor the plurality of C-RTWT agreements in the neighborhood of the AP in particular for determining start time protection rules (STPR) congestion and sparsity. STPRs are used to manage network congestion and improve efficiency in dense environments. Generally, network congestion occurs when a demand for network resources exceeds available network resources capacity, and thereby leading to delays, packet loss, and degraded performance. Further, as described herein, STPRs provide or encapsulate coordinating transmission start times such that the APs transmission conclude prior to a neighboring AP's transmission begins and thereby preventing interference and improve overall network performance.

The method operations may include determining, at step 404, using the plurality of C-RTWT agreements, a parameter indicative of congestion or sparsity of Start Time Protection Rules (STPRs) in the neighborhood. In particular, based on the plurality of C-RTWT agreements specifying coordinated activities and interactions, the congestion or sparsity of STPRs may be inferred. In some examples, the congestion or sparsity of STPRs may be determined based upon one or more of jitter analysis, a packet loss count, a round-trip time (RTT) increase, and an increase in bandwidth utilization, etc.

The method operations may include modifying, at step 406, at least one C-RTWT agreement of the plurality of C-RTWT agreements to reach a target spacing among the STPRs. In some examples, the target metric may an even spacing of STPRs. In some examples, the target metric may be one STPR at every 2 milliseconds (ms) duration on average. The modified C-RTWT agreement is exchanged with the neighboring APs, preferably, over a secure tunnel.

FIG. 4B illustrates an example method operation for modifying C-RTWT agreement according to some aspects of the present disclosure As shown in FIG. 4B, an example method operation for modifying C-RTWT agreement (of step 406 of FIG. 2A) includes determining, at step 406a, a spacing between two most-widely-spaced STPRs among the STPRs, and determining, at step 406b, a corresponding Service Interval (SI) and a corresponding Service Start Time (SST) of the at least one C-RTWT agreement based on the spacing determined at step 406a.

In some examples, upon determining, at step 406a, the spacing between two most-widely-spaced STPRs is at least a first threshold value, a common SI and an SST that is midway (or midpoint) between the two most-widely-spaced STPRs are selected by the AP at step 406b. The first threshold value is about 2*T (where T is a defined time period and is 2 ms, for example).

In some examples, upon determining, at step 406a, that the spacing between two most-widely-spaced STPRs exceeds the first threshold value, the AP selects a common SI and an SST that is after the earlier of the two most-widely-spaced STPRs at step 406b.

In some examples, upon determining, at step 406a, that the spacing between two most-widely-spaced STPRs exceeds a threshold value of 3*T (where T is a defined time period and is 3 ms, for example), the AP selects an SI and an SST of the at least one C-RTWT agreement of multiple C-RTWT agreements. This example is shown as a diagram 400c in FIG. 4C.

As shown in FIG. 4C, the AP, at step 408, generates multiple C-RTWT agreements (also referenced herein as a second plurality of C-RTWT agreements). Each C-RTWT agreement of the second plurality of C-RTWT agreements is indexed by n, where a value of n is 1, 2, . . . , N (where N=two or more). Next, an SI and an SST corresponding to each C-RTWT agreement of the second plurality of C-RTWT agreements is determined at step 410. By way of a non-limiting example, the SI and the SST corresponding to each C-RTWT agreement is determined to be equal to the corresponding index value multiplied by a threshold time after an earlier STPR of the two most-widely-spaced STPRs. The threshold being determined as a multiple of a defined time period (such as T and having a value of 2 ms, for example).

In some examples, the value of N may be chosen as round(widest spacing/T)−1. Alternatively, the value of N may be randomly selected. Further, the value of N may be selected such that an AP cannot have a C-RTWT agreement with an STPR rate that is higher (or exceeds a predetermined threshold value) than an STPR rate of a neighboring AP (or any neighboring AP) of the AP. In some examples, each AP of the plurality of APs has to cede RTWT agreement(s) to neighboring APs with a lower STPR rate upon demand from a neighboring AP.

Step 408 and step 410 described herein are optional steps as they are performed upon being a specific criterion (that the spacing between two most-widely-spaced STPRs exceeds a threshold value of 3*T) being met or occurred. Further, a number of the second plurality of C-RTWT agreements is determined based on the spacing and the threshold time.

In some examples, if any AP in the neighborhood of the AP departs (for example, by being powered down, channel switching, etc.), the other APs can perform the same processing as described above including modifying an C-RTWT agreement as shown in a flow-chart diagram 400d of FIG. 4D showing many different optional steps. As shown in FIG. 4D, at step 412, the AP may detect that one or more neighboring APs have stopped corresponding transmissions. The one or more neighboring APs may stop transmission upon being powered down, or due to a change in the transmission channel, etc., and in response to detecting that the neighboring AP has stopped the corresponding transmissions, the AP, at step 414, may modify at least one C-RTWT agreement.

FIG. 4E illustrates an example method when the AP detects a drift of its STPRs into the STPRs of another AP. As shown in diagram 400e of FIG. 4E, the AP, at step 416, determines that at least one of STPRs of the AP is drifting into at least one STPR of a neighboring AP, and in response to the determining at step 416, the AP at step 418 may modify a corresponding SST of the at least one C-RTWT agreement. At step 420, the AP may signal the modified SST to the one or more neighboring APs, for example, via a secure tunnel.

FIG. 4F illustrates an example method when the AP detects that a different SST would increase the average STPR spacing across all nearby APs. As shown in diagram 400f of FIG. 4F, the AP, at step 422, determines that modifying a corresponding SST of the at least one C-RTWT agreement would increase average spacing between the STPRs across all neighboring APs, and based on the determination at step 422, the AP may modify the corresponding SST at step 424, and signal the modified SST to the one or more neighboring APs at step 426, for example, via a secure tunnel.

In some examples, if there are adjacent administrative domains that do not agree on a common SI, each administrative domain may select a sufficiently different SI so that back-to-back collision or an average collision between very close (or same time) STPRs occur infrequently or rarely. An administrative domain, as described herein, refers to a collection of network resources including one or more APs, and/or one or more STAs that are managed and controlled by a single entity or administrator.

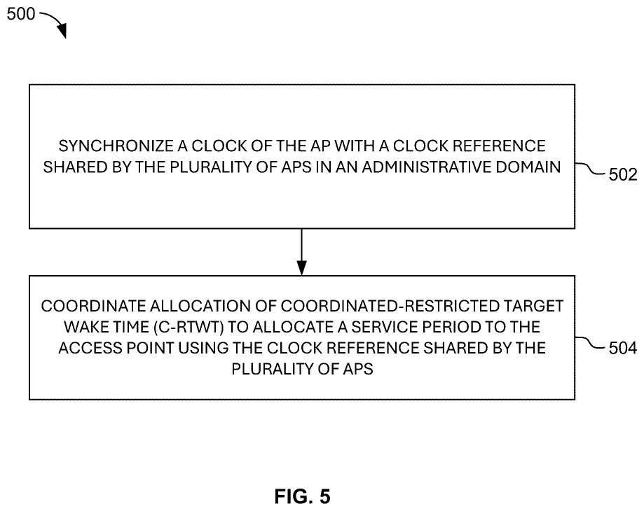

FIG. 5 illustrates another example of operation according to some aspects of the present disclosure. The method operations may be performed by an AP (e.g., AP MLD1 304) of a plurality of APs (e.g., AP MLD1 304, AP MLD2 306, and AP MLD3 308) for coordinating transmissions in a wireless network. Alternatively, operations of FIG. 4A may be performed by an AP or network controller such as switch 110 described above as being able to operate as a centralized controller of different APs.

According to flowchart 500 of FIG. 5 as step 502, to minimize STPRs from drifting with reference to each other, the AP may synchronize a clock of the AP with a reference clock shared by a plurality of other APs in the same administrative domain. Further, as shown as step 504, the AP may coordinate allocation of C-RTWT to allocate a service period to the AP using the clock reference shared by the plurality of other APs in the same administrative domain. Thus, the same clock reference, which may be a GPS clock, is available to each AP of the plurality of APs in each administrative domain of the plurality of administrative domains.

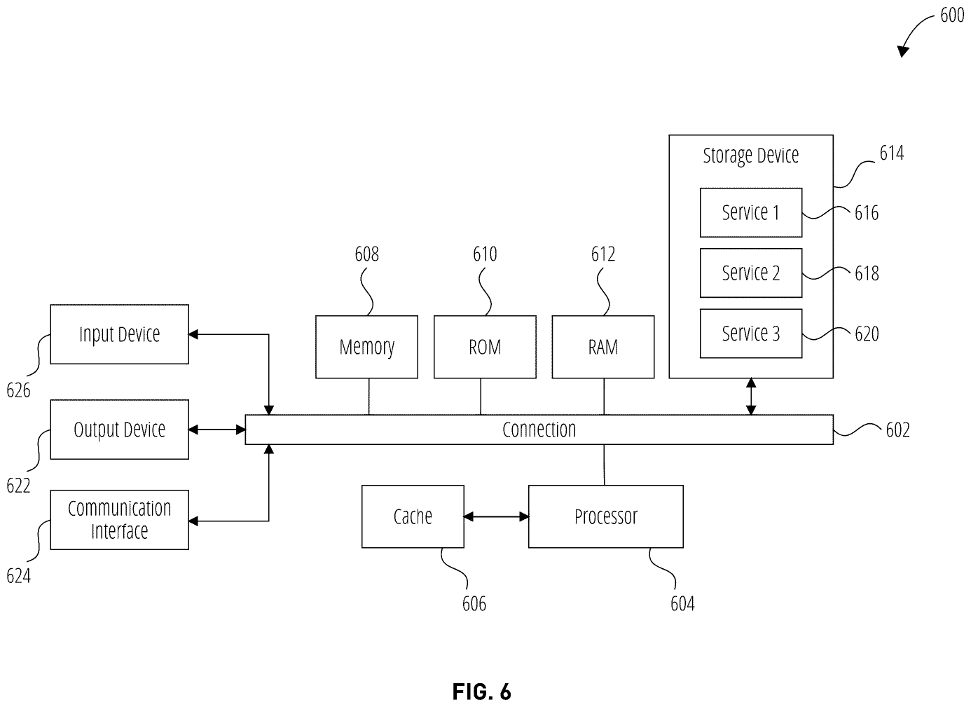

FIG. 6 shows an example of computing system 600, which can be for example any computing device making up APs 102, switch 110, STAs 104, or any component thereof, in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some examples, computing system 600 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example computing system 600 includes at least one processing unit (CPU or processor) such as processor 604 and connection 602 that couples various system components including system memory 608, such as read-only memory (ROM) such as ROM 610 and random-access memory (RAM) such as RAM 612 to processor 604. Computing system 600 can include a cache of high-speed memory 606 connected directly with, in close proximity to, or integrated as part of processor 604.

Processor 604 can include any general-purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some examples, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some examples, a service is a program or a collection of programs that carry out a specific function. In some examples, a service can be considered a server. The memory can be a non-transitory computer-readable medium.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method for coordinating transmissions by an access point (AP) of a plurality of APs in a wireless network comprising:
monitoring, by the AP, a plurality of Coordinated-Restricted Target Wake Time (C-RTWT) agreements in a neighborhood of the AP;
determining, by the AP and using the plurality of C-RTWT agreements, a parameter indicative of congestion or sparsity of Start Time Protection Rules (STPRs) in the neighborhood; and
modifying, by the AP, at least one C-RTWT agreement of the plurality of C-RTWT agreements to reach a target spacing among the STPRs.

2. The method of claim 1, wherein modifying the at least one C-RTWT agreement comprises:
determining a spacing between two most-widely-spaced STPRs among the STPRs; and
determining a corresponding Service Interval (SI) and a corresponding Service Start Time (SST) of the at least one C-RTWT agreement based on the spacing.

3. The method of claim 2, wherein the corresponding SI and the corresponding SST are set equal to a midpoint between the two most-widely-spaced STPRs if the spacing is equal to a first threshold.

4. The method of claim 3, wherein the first threshold is twice a defined time period.

5. The method of claim 2, wherein the corresponding SI and the corresponding SST are set equal to a threshold time after an earlier STPR of the two most-widely-spaced STPRs if the spacing exceeds twice a first threshold.

6. The method of claim 2, wherein the plurality of C-RTWT agreements is a first plurality of C-RTWT agreements, and the method further comprising:
generating a second plurality of C-RTWT agreements if the spacing exceeds a threshold, wherein each C-RTWT agreement of the second plurality of C-RTWT agreements having a corresponding index; and
determining a corresponding SI and a corresponding SST for each C-RTWT agreement of the second plurality of C-RTWT agreements to be equal to the corresponding index multiplied by a threshold time after an earlier STPR of the two most-widely-spaced STPRs, the threshold time being determined as a multiple of a defined time period.

7. The method of claim 6, wherein a number of the second plurality of C-RTWT agreements is determined based on the spacing and the threshold time.

8. The method of claim 7, wherein the AP cannot have a C-RTWT agreement with a STPR rate higher than a corresponding STPR rate of any neighboring AP.

9. The method of claim 7, wherein the AP cedes any C-RTWT agreement to a neighboring AP with a lower STPR upon receiving a demand from the neighboring AP.

10. The method of claim 1, further comprising:
detecting that a neighboring AP has stopped corresponding transmissions; and
modifying the at least one C-RTWT agreement in response to detecting that the neighboring AP has stopped the corresponding transmissions.

11. The method of claim 1, further comprising:
determining that at least one of the STPRs of the AP is drifting into at least one STPR of a neighboring AP;
modifying a corresponding SST of the at least one C-RTWT agreement in response to determining that the at least one of the STPRs is drifting into the at least one STPR of the neighboring AP; and
signaling adjacent APs including the neighboring AP that the corresponding SST has been modified.

12. The method of claim 1, further comprising:
determining that modifying a corresponding SST of the at least one C-RTWT agreement increases average spacing between the STPRs across all neighboring APs;
modifying the corresponding SST in response to determining that the average spacing will increase; and
signaling adjacent APs including all neighboring APs that the corresponding SST has been modified.

13. The method of claim 1, further comprising:
signaling modifications to the at least one C-RTWT agreement to a neighboring AP via a secure tunnel.

14. A method for coordinating transmissions by an access point (AP) of a plurality of APs in a wireless network comprising:
synchronizing a clock of the AP with a clock reference shared by the plurality of APs in an administrative domain; and
coordinating allocation of Coordinated-Restricted Target Wake Time (C-RTWT) to allocate a service period to the access point using the clock reference shared by the plurality of APs.

15. The method of claim 14, wherein the clock reference is available to each AP of the plurality of APs in each administrative domain of a plurality of administrative domains.

16. The method of claim 14, wherein the clock reference is based on a GPS clock.

17. An access point (AP) of a plurality of APs in a wireless network comprising:
at least one memory configured to store computer-readable instructions; and
at least one processor communicatively coupled with the at least one memory and configured to execute the computer-readable instructions to:
monitor a plurality of C-RTWT (Coordinated-Restricted Target Wake Time) agreements in a neighborhood of the AP;
determine, using the plurality of C-RTWT agreements, a parameter indicative of congestion or sparsity of Start Time Protection Rules (STPRs) in the neighborhood; and
modify at least one C-RTWT agreement of the plurality of C-RTWT agreements to reach a target spacing among the STPRs.

18. The AP of claim 17, wherein modifying the at least one C-RTWT agreement comprises:
determining a spacing between two most-widely-spaced STPRs among the STPRs; and
determining a corresponding Service Interval (SI) and a corresponding Service Start Time (SST) of the at least one C-RTWT agreement based on the spacing.

19. The AP of claim 18, wherein the corresponding SI and the corresponding SST are set equal to a midpoint between the two most-widely-spaced STPRs if the spacing is equal to a first threshold, and wherein the first threshold is twice a defined time period.

20. The AP of claim 18, wherein the corresponding SI and the corresponding SST are set equal to a threshold time after an earlier STPR of the two most-widely-spaced STPRs if the spacing exceeds twice a first threshold.
